(19) United States
(12) Patent Application Publication
(10) Pub. No.: US 2023/0356562 A1
(43) Pub. Date: Nov. 9, 2023

(54) A Hybrid Air Conditioning System for Automobile

(71) Applicant: THERMAX LIMITED, Pune (IN)

(72) Inventors: Devadatta Pundlik NAVALE, Pune (IN); Amol Jambukumar BHARAMGONDA, Pune (IN)

(21) Appl. No.: 18/044,849

(22) PCT Filed: Aug. 27, 2021
(86) PCT No.: PCT/IB2021/057861

§ 371 Date: Mar. 10, 2023

(30) Foreign Application Priority Data
Aug. 28, 2020 (IN) 202021037191

(51) Int. Cl. B60H 1/00; B60H 1/32

(52) U.S. Cl. CPC B60H 1/00878; B60H 1/00007; B60H 1/00364; B60H 1/3204; B60H 1/32014

(57) ABSTRACT

The present disclosure relates to the field of hybrid air conditioning for automobiles and controlling system thereof, and envisages a hybrid air conditioning system (10) for cooling a passenger cabin of an automobile having an engine (30). The system (10) comprises a metal hydride based air conditioning subsystem, a vapor compression based air conditioning subsystem, a first sensor, a second sensor and a control unit. The first sensor is mounted in the passenger cabin to sense temperature inside the passenger cabin to generate a first sensed signal. The second sensor is configured to sense temperature of exhaust gases to generate a second sensed signal. The control unit cooperates with the first sensor and the second sensor, to selectively actuate either the metal hydride based air conditioning subsystem or the vapor compression based air conditioning subsystem based on the first and second sensed signals.

### FIELD

The present disclosure generally relates to the field of air conditioning systems. Particularly, the present disclosure relates to the field of hybrid air conditioning for automobiles and controlling system thereof.

### BACKGROUND

The background information herein below relates to the present disclosure but is not necessarily prior art.

The field of automobile air conditioning system generally comprises vapour compression based air conditioning systems, wherein the compressor is driven by a fossil-fuel-driven engine. In the process, the refrigerant goes through various phases of refrigeration cycle with a compressor, a condenser, a thermal expansion valve and an evaporator to complete a refrigeration cycle, in order to cool the space inside the vehicle. Nonetheless, the vapour compression based cooling systems do require high energy consumption and affect the environment. To realize the energy conservation of automobile air conditioners, for instance, Chinese patent CN1482017, titled: “The two-stage metal hydride automobile air conditioner”, discloses use of adsorption of hydrogen from metal hydride and absorption, so as to realize the refrigeration effect, which converts the heat generated in automobile exhaust and uses that heat for cooling in an automobile air conditioner, thus realizing the recovery of the automobile tail gas as a useful energy. However, the refrigeration process here is only dependent on the quantity of heat of the recirculated exhaust gas which cannot sufficiently meet the requirement of continuous cooling in an automobile air conditioner.

A metal hydride heat pump operates in a cyclic nature. A pair of two different types of metal hydrides are used, viz., a regenerating alloy A and a refrigerating alloy B, as the sorbent, and hydrogen as the process fluid. In the first cycle of operation of paired reactors of alloys A and B, alloy A discharges hydrogen using a first medium as a high temperature heat source. The discharged hydrogen is absorbed by the alloy B and in the process heat is rejected to a second medium, typically ambient air. In the second cycle, the alloy B desorbs hydrogen using a third stream of a low temperature heat source. The discharged hydrogen is absorbed by the alloy A and in the process, heat is rejected to the fourth stream, typically ambient air. Thus, the operation of the metal hydride heat pump requires each alloy to go through a temperature swing for charging and discharging. Thus, in an air conditioning system that is based on metal hydride reactors for implementation of the heat pump for mobile applications in vehicles, the cooling effect and performance depend mainly on these two driving factors: (a) the exhaust gas mass flow rate and (b) the temperature of the exhaust gas. During the course of operation of the vehicle and the air conditioner, if either of these driving factors is affected and if their values fall beyond values for optimal operation, the overall system performance and eventually the cooling capacity of the system decreases. The events that lead to or during which decrease in the exhaust gas flow and its temperature can be expected are as follows: during cold start up, during idling of the engine without any vehicle movement, no load of passengers in the vehicle, travel of vehicle downhill or travel of vehicle at very low speeds in crowded areas such as city traffic, toll plazas etc.

All the above mentioned events are specifically related to low speed and/or low torque characteristics of the vehicle engine. Hence, the underperformance of the standalone metal hydride air conditioning system (MH) during the above mentioned events can lead to passenger discomfort. The above mentioned problems can be solved by integrating the conventional vapour compression (VC) system with the existing MH. In the occurrence of one of the above listed events, there will not be enough exhaust heat available for the MH. During such events, the vapour compression (VC) system would pitch in and cool the cabin air to the extent of allowable comfort level. Again, for the mentioned purpose, the mere use of two individual air conditioning systems (a MH and a conventional VC system) that work independent of each other and need to be individually operated would lead to complicated and troublesome operation, requiring constant human intervention for its operation. Further, implementation of two individual systems would not only increase the cost of implementation of an air conditioning system, but also, add to the overall weight of the system.

Hence, it has been realized that there is a need for a hybrid air conditioning system that implements metal hydride reactors along with a conventional vapour compression system, for providing continuous cooling, but in an integrated manner such that it solves the above mentioned problems. Another challenge in developing such as system is to optimize the tradeoff between form factor and performance. The aim is to have a system such that its integration maps the functionality on to the structural components so as to minimize the costs of design, fabrication, assembly and installation. Further, the switching from metal hydride mode to vapour compression mode should also be an energy efficient, predictable, real-time and reliable system with minimum maintenance and servicing capability.

Hence, there is a need of a hybrid MH-VC air conditioning system for automobiles that addresses all of the aforesaid issues and requirements.

### OBJECTS

Some of the objects of the present disclosure, which at least one embodiment herein satisfies, are as follows:

It is an object of the present disclosure to overcome the above listed drawbacks of known air conditioning systems for automobiles. Accordingly, an object of the present disclosure is to provide a hybrid metal hydride (MH) and vapour compression (VC) air conditioning system for automobiles that provides energy efficient and uninterrupted cooling.

Another object of the present disclosure is to provide a hybrid MH-VC air conditioning system for automobiles with a system and a method of operation for optimized control.

A yet another object of the present disclosure is to provide a hybrid MH-VC air conditioning system for automobiles that augments the tradeoff concerning the form factor and performance.

Other objects and advantages of the present disclosure will be more apparent from the following description, which is not intended to limit the scope of the present disclosure.

### SUMMARY

The present disclosure envisages a hybrid air conditioning system for cooling a passenger cabin of an automobile, the automobile having an engine. The system comprises a metal hydride based air conditioning subsystem and a vapor compression based air conditioning subsystem. The system also comprises at least one first sensor, at least one second sensor and a control unit. The first sensor is mounted in the passenger cabin of the automobile and configured to sense temperature inside the passenger cabin to generate a first sensed signal. The second sensor is configured to sense temperature of exhaust gases emitted from the engine to generate a second sensed signal. The control unit is configured to cooperate with the first sensor and the second sensor, and to selectively actuate either the metal hydride based air conditioning subsystem or the vapor compression based air conditioning subsystem based on the first and second sensed signals.

The engine has an exhaust unit for emitting exhaust gases therefrom. The second sensor is mounted in the exhaust unit for sensing temperature of the exhaust gases emitted from the exhaust unit.

The control unit includes a memory, a converter and a controller. The memory is configured to store a predetermined temperature value of the passenger cabin, a predetermined temperature value of the exhaust gases, a first predetermined time period, and a second predetermined time period. The converter is configured to convert the first and second sensed signals to a first sensed signal value and a second sensed signal value respectively. The controller is configured to cooperate with the converter and the memory. The controller further includes a first comparator, a second comparator and a switching unit. The first comparator is configured to compare the first sensed signal value with the predetermined temperature value of the passenger cabin. The second comparator is configured to compare the second sensed signal value with predetermined temperature value of the exhaust gases. The switching unit is configured cooperate with the controller and the memory, and to selectively generate a first a first activation signal, a second activation signal or a third activation signal. The first activation signal is generated by the switching unit for activating the metal hydride based air conditioning subsystem, when the first sensed signal value is less than the predetermined temperature value of the passenger cabin and the second sensed signal value is greater than or equal to the predetermined temperature value of the exhaust gases. The second activation signal is generated by the switching unit for activating the vapor compression based air conditioning subsystem, when the first sensed signal value is greater than or equal to the predetermined temperature value of the passenger cabin and the second sensed signal value is less than the predetermined temperature value of the exhaust gases. The third activation signal is generated by the switching unit when the first sensed signal value is greater than or equal to the predetermined temperature value of the passenger cabin and the second sensed signal value is greater than the predetermined temperature value of the exhaust gases.

In a preferred embodiment, the controller further includes a first timer, a second timer and a third timer. The first timer is configured to generate a compression cycle activation signal for activating the vapor compression based air conditioning subsystem, upon receiving the third activation signal, for the first predetermined time period. The second timer is configured to cooperate with the first timer, and to generate a compression cycle deactivation signal for deactivating the vapor compression based air conditioning subsystem, upon completion of the first predetermined time period, for the second predetermined time period. The third timer is configured to cooperate with the second timer, and to generate a compression cycle activation signal for activating the vapor compression based air conditioning subsystem, upon completion of the second predetermined time period, for a third predetermined time period stored in the memory.

In an embodiment, the second timer is configured to generate a compression cycle deactivation signal for deactivating the vapor compression based air conditioning subsystem, upon completion of the third predetermined time period, for the second predetermined time period.

In an advantageous embodiment, the system includes at least one third sensor, a third comparator and a magnetic clutch. The third sensor is mounted on the engine of the automobile and is configured to sense speed of the engine to generate a third sensed signal. The third comparator, in the control unit, is configured to compare a value of the third sensed signal with a first predetermined speed value and a second predetermined speed value stored in the memory. The magnetic clutch is configured to engage a compressor of the vapor compression based air conditioning subsystem with the engine when value of the third sensed signal is less than a first predetermined speed value. The magnetic clutch is also configured to disengage the compressor of the vapor compression based air conditioning subsystem from the engine when value of the third sensed signal is greater than the second predetermined speed value.

In an embodiment, the metal hydride based air conditioning subsystem comprises a first heat exchanger, a second heat exchanger, a third heat exchanger and a fourth heat exchanger. The first heat exchanger is configured to continuously absorb heat from the passenger cabin of the automobile and release cooled air to the passenger cabin of the automobile. The first heat exchanger houses a cold side reactor bank. The second heat exchanger is configured to continuously release heat to ambient air outside the automobile. The second heat exchanger houses a first ambient side reactor bank. The third heat exchanger is configured to continuously release heat generated by the exhaust gases to ambient air outside the automobile. The third heat exchanger houses a second ambient side reactor bank. The fourth heat exchanger is configured to continuously absorb heat generated by the exhaust gases emitted by the exhaust unit. The third heat exchanger houses a hot side reactor bank.

Typically, the first and second heat exchangers are disposed within a low temperature module, and the third and fourth heat exchangers are disposed within a high temperature module.

Preferably, the second and third heat exchangers are coupled with at least one heat rejection fan to release the heat to ambient air, outside the automobile. Also, the first heat exchanger is coupled to at least one blower to induce cooled air into the passenger cabin of the automobile.

The vapor compression based air conditioning system comprising an evaporator, a compressor, a condenser and an expansion valve.

The system a cold chamber enclosing the first heat exchanger and the evaporator, an ambient chamber enclosing the second heat exchanger, the condenser and the third heat exchanger, and a hot chamber enclosing the fourth heat exchanger.

The present disclosure also envisages a method for controlling actuation an air conditioning system for cooling a passenger cabin of an automobile, the automobile having an engine. The method comprising following steps:
sensing, by at least one first sensor, temperature inside a passenger cabin of an automobile;
generating, by the first sensor, first sensed signal based on the temperature inside the passenger cabin;
sensing, by at least one second sensor, temperature of exhaust gases emitted by an exhaust unit;
generating, by the second sensor, second sensed signal based on the temperature of exhaust gases emitted by the exhaust unit;
receiving, by a control unit, the first sensed signal and the second sensed signal; and
selectively actuating, by the control unit, either the metal hydride based air conditioning subsystem or the vapor compression based air conditioning subsystem based on the received first and second sensed signals.

### BRIEF DESCRIPTION OF THE ACCOMPANYING DRAWING

The MH-VC hybrid air conditioning system of the present disclosure will now be described with the help of the accompanying drawing, in which:

FIG. 1 illustrates an embodiment of air conditioning system in a vehicle with integrated VC system with MH system, including low temperature (LT) and high temperature (HT) module configuration, wherein the HT and LT units are disposed at the roof of the vehicle;

FIG. 2 illustrates an embodiment of air conditioning system in a vehicle with integrated VC system with MH system, including LT and HT module configuration, wherein the HT unit is placed at the bottom part of the vehicle;

FIG. 3 illustrates an air conditioning system in a vehicle with integrated vapour compression (VC) system and metal hydride air conditioning (MH) system, including low temperature (LT) module configuration;

FIG. 4 illustrates a flow chart showing the method of operation of the MH-VC hybrid air conditioning system; and

FIG. 5 illustrates the performance of the MH-VC hybrid air conditioning system, showing a pattern of uniform cooling as flattened crests on the activation of the compressor along with thermally activated cooling of MH.

### LIST OF REFERENCE NUMERALS

10 MH-VC hybrid air conditioning system
20 Vehicle body
30 Engine
40 Cold air blower
50 Cold chamber
60 Ambient chamber
70 Hot chamber
110 Cold side reactor
120a, 120b Ambient side reactors
130 Hot side reactor
140a, 140b Heat rejection fans
140c exhaust gas blower fan
150 Hydrogen line
210 Evaporator
230 Condenser
240 Expansion valve
250 Refrigerant line
310 Exhaust unit
320 Exhaust gas pump
330 Exhaust gas flow line
A1 Return air from vehicle cabin to the cooling module
A2 Ambient air
A3 Cold air
A4 Hot air exiting ambient chamber
tc Compressor ON time period
Tₐᵢ Ambient chamber inlet temperature
Tₐₒ Ambient chamber outlet temperature
Tₑᵢ Cold chamber inlet temperature
Tₑₒ Cold chamber outlet temperature

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a”, “an” and “the” may be intended to include the plural forms as well, unless the context clearly suggests otherwise. The terms “comprises”, “comprising”, “including” and “having” are open ended transitional phrases and therefore specify the presence of stated features, elements, modules, units and/or components, but do not forbid the presence or addition of one or more other features, elements, components, and/or groups thereof.

The terms first, second, third, etc., should not be construed to limit the scope of the present disclosure as the aforementioned terms may be only used to distinguish one element, component or section from another component or section. Terms such as first, second, third etc., when used herein do not imply a specific sequence or order unless clearly suggested by the present disclosure.

The present disclosure envisages an air conditioning system and a method for controlling the air conditioning system in automobiles. The disclosed hybrid air conditioning system, also termed as a metal hydride (MH) cum vapour compression (VC), i.e., MH-VC hybrid air conditioning system 10, for cooling a passenger cabin of an automobile having an engine 30. The MH-VC hybrid air conditioning system 10 comprises: a metal hydride based air conditioning subsystem, a vapour compression based air conditioning subsystem, a first sensor mounted in the passenger cabin of automobile, configured to sense temperature inside said passenger cabin and generate a first sensed signal, a second sensor configured to sense temperature of exhaust gases emitted from the engine 30 and generate a second sensed signal, a control unit configured to cooperate with first sensor and second sensor, and then selectively actuate either metal hydride based air conditioning subsystem or said vapour compression based air conditioning subsystem, based on the first and second sensed signals.

The low temperature (LT) module of the metal hydride based air conditioning subsystem comprises two heat exchangers, i.e., a first heat exchanger and a second heat exchanger. The first heat exchanger comprising the cold side reactor bank 110 is exposed to at least one blower fan 40 and is configured to continuously absorb heat from the air coming from passenger cabin of the automobile and release cooled air to the passenger cabin of the automobile. The second heat exchanger comprising the first ambient side reactor bank 120a is exposed to a first heat rejection fan 140a and is configured to continuously release heat to ambient air outside the automobile.

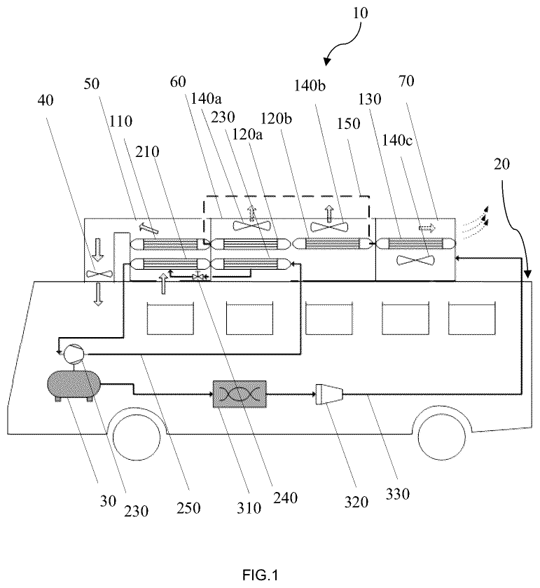

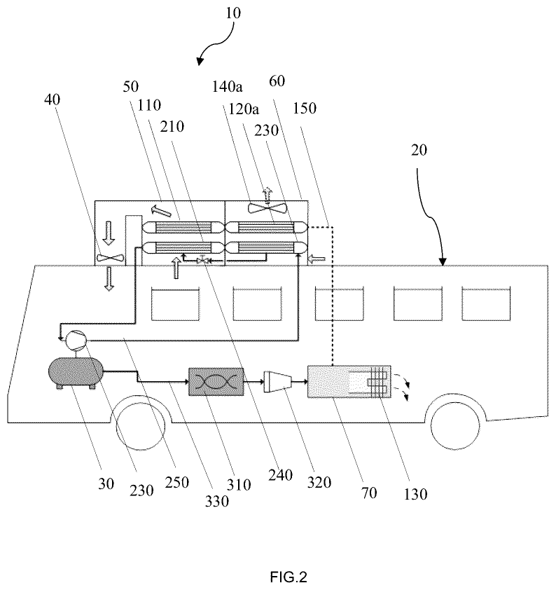

The engine 30 has an exhaust unit 310, typically a silencing and exhaust aftertreatment apparatus, for emitting exhaust gases therefrom. The second sensor is mounted in the exhaust unit 310 for sensing temperature of the exhaust gases emitted from the exhaust unit. Exhaust gas pump 320 and the exhaust gas flow line 330 are as shown in FIGS. 1 and 2.

The high temperature (HT) module of the metal hydride based air conditioning subsystem also comprises two heat exchangers, i.e., a third heat exchanger and a fourth heat exchanger.

The third heat exchanger comprising the second ambient side reactor bank 120b is exposed to a second heat rejection fan 140b and is configured to continuously release heat generated by the exhaust gases to the ambient air outside the automobile. The fourth heat exchanger comprising the hot side reactor bank 130 is configured to continuously absorb heat generated by the exhaust gases emitted by the exhaust unit. In the embodiment shown in FIG. 1, The fourth heat exchanger is exposed to an exhaust gas blower fan 140c.

Thus, the LT module comprises the cold chamber 50 and a half of the ambient chamber 60. The HT module comprises the remaining half of the ambient chamber 60 and the hot chamber 70.

The metal hydride reactor banks 110, 120a, 120b, 130 are disposed within the respective heat exchangers. Each of the metal hydride reactors comprises two metal hydride alloys that use hydrogen as the working fluid, wherein the plurality of metal hydride reactors effectuates transfer of heat by the first, second, third and fourth heat exchangers.

The vapour compression based air conditioning system comprises an evaporator 210, a compressor (not shown), a condenser unit 230, and an expansion valve 240. The evaporator 210 is configured to continuously absorb heat from the passenger cabin of the automobile by a low pressure and low temperature liquid refrigerant flowing through a refrigerant line 250 to obtain a low temperature and low pressure vapour. The compressor is driven by the engine 30 of the automobile, and is configured to compress the low temperature and low pressure vapour refrigerant leaving the evaporator 210 to obtain a high pressure and high temperature vapour refrigerant. The condenser 230 is configured to condense the high pressure and high temperature vapour refrigerant leaving the compressor to obtain a high pressure and high temperature liquid refrigerant. The expansion valve 240 is configured to reduce pressure and temperature of the high pressure and high temperature liquid refrigerant leaving the condenser 230 to obtain the low pressure and low temperature liquid refrigerant that is passed continuously to the evaporator 210.

FIG. 1 and FIG. 2 illustrate two different embodiments of the present invention, wherein FIG. 1 shows the preferred embodiment when there is no space in the automobile/bus layout of the vehicle body 20 or the bus is a low-floored bus where the hot chamber 70 of the high temperature unit is installed on the roof of the vehicle body 20 and FIG. 2 shows the preferred embodiment where the hot chamber 70 of the high temperature unit is installed inside the vehicle body 20. The embodiment shown in FIG. 2 mitigates issues like temperature and pressure drop in tapping the exhaust gas while pumping it to activate the high temperature unit. Further, the embodiment in FIG. 2 reduces the size of the on-roof unit, reducing drag force on the vehicle, making it more aerodynamic.

FIG. 1 of the accompanying drawings illustrates an embodiment of a vehicle with the MH-VC hybrid air conditioning system 10, including an LT and HT module configuration, wherein the HT and LT units, i.e., the cold chamber 50, the ambient chamber 60 and the hot chamber 70 are disposed on the roof of the vehicle, which is the preferred embodiment when there is no space in the bus body layout/the bus is a low floored bus.

FIG. 2 of the accompanying drawings illustrates an embodiment of a vehicle with the MH-VC hybrid air conditioning system 10, including an LT and HT module configuration, wherein the hot chamber 70 of the HT unit is placed at the bottom part of the vehicle, which is the preferred embodiment to mitigate issues like temperature and pressure drop in tapping the exhaust gas while pumping it to activate the HT unit.

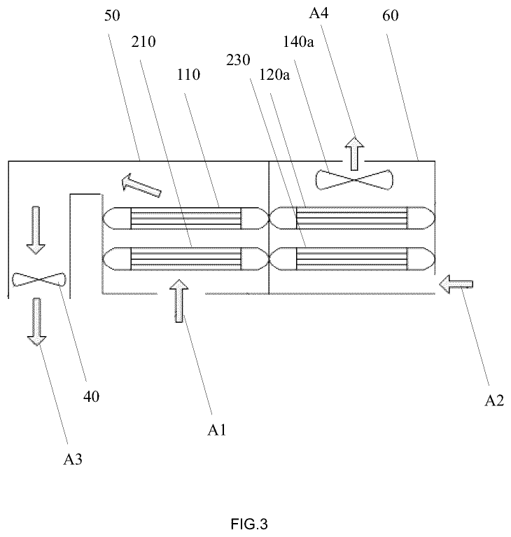

FIG. 3 illustrates the low temperature (LT) module of the MH-VC hybrid air conditioning system. The cold chamber 50 and the LT portion of the ambient chamber 60 are placed sideways, wherein the cold chamber 50 comprises a cold side reactor bank 110 of a metal hydride that undergoes desorption of hydrogen, and the evaporator 210 of the vapour compression (VC) system. The LT part of the ambient chamber 60 comprises an LT ambient side reactor bank 120a of a metal hydride that undergoes absorption of hydrogen, and a condenser 230 of the vapour compression system. A blower 40 is placed to supply cold air to the vehicle cabin. A centrifugal heat rejection fan 140a is placed to reject heat to ambient air. The arrow A1 indicates the flow direction of return air from vehicle cabin to the cold chamber 50. The return air gets cooled over the cold side reactor bank 110 through desorption of hydrogen and over the evaporator 210 of the vapour compression system. The cold air is supplied back to the vehicle cabin as shown by the arrow A3. The ambient air shown by the arrow A2 comes in and takes the heat from the LT ambient side reactor bank 120a of MH under absorption of hydrogen and the condenser 230 of the vapour compression system. The hot air, after taking the heat from the LT ambient side reactor bank 120a of the MH under absorption of hydrogen and from the condenser 230 of the vapour compression system, exits the system to flow out into the surroundings, as shown by the arrow A4.

In the preferred embodiment as shown in FIG. 3, the orientation and mounting of the condenser 230 and the evaporator 210 does not need separate casings/enclosures for the VC and MH systems, wherein the same fan can be used to reject heat from the LT ambient side reactor bank 120a of the MH under absorption of hydrogen and the condenser 230 of the vapour compression system, and the same blower 40 can be used to cool the air over the cold side reactor bank 110 of MH under desorption of hydrogen and the evaporator 210 of the vapour compression system.

In an operative embodiment of the present disclosure, the control unit of the MH-VC hybrid air conditioning system includes a memory configured to store a predetermined temperature value of the passenger cabin, a predetermined temperature value of the exhaust gases, a first predetermined time period, and a second predetermined time period. The control unit further includes a converter configured to convert the first and the second sensed signals to a first sensed signal value and a second sensed signal value, respectively. The convertor may be an analog-to-digital converter. The control unit further includes a controller that cooperates with the converter and the memory and includes a first comparator and a second comparator that are configured to compare the first sensed signal value and second sensed signal value respectively with the predetermined temperature value of the passenger cabin and exhaust gases, respectively.

The predetermined temperature value of the passenger cabin is typically, but not limited to 27° C., the predetermined temperature value of the exhaust gases is typically, but not limited to 250° C., the first predetermined time period is typically, but not limited to 100 seconds, and the second predetermined time period is typically, but not limited to 180 seconds.

The control unit further includes a switching unit that cooperates with the controller and the memory, and selectively generates a first activation signal, a second activation signal or a third activation signal based on the outputs of the first and the second comparators. The controller generates the first activation signal for activating the metal hydride based air conditioning subsystem, when the first sensed signal value is less than the predetermined temperature value of the passenger cabin and the second sensed signal value is greater than or equal to the predetermined temperature value of the exhaust gases. The controller generates the second activation signal for activating the vapour compression based air conditioning subsystem, when the first sensed signal value is greater than or equal to the predetermined temperature value of the passenger cabin and the second sensed signal value is less than the predetermined temperature value of the exhaust gases. Such a state for generation of the second activation signal occurs during either cold start up or during idling of the engine or when there is no load of passengers in the vehicle or during travel of vehicle downhill or travel of the vehicle at very low speeds in crowded areas such as city traffic, toll plazas etc. The controller generates the third activation signal, when the first sensed signal value is greater than or equal to the predetermined temperature value of the passenger cabin and the second sensed signal value is greater than or equal to the predetermined temperature value of the exhaust gases.

The controller further includes a first timer configured to generate a compressor activation signal of the vapour compression based air conditioning subsystem, upon receiving the third activation signal, for the first predetermined time period, a second timer configured to cooperate with the first timer, and is further configured to generate a compressor deactivation signal for deactivating the compressor of the vapour compression based air conditioning subsystem, upon completion of the first predetermined time period, for the second predetermined time period, and a third timer configured to cooperate with the second timer, and is further configured to generate a compressor activation signal for activating the compressor of the vapour compression based air conditioning subsystem, upon completion of the second predetermined time period, for the third predetermined time period. The second timer is further configured to generate a compressor deactivation signal for deactivating the compressor of the vapour compression based air conditioning subsystem, upon completion of the third predetermined time period, for the second predetermined time period. For instance, when the vehicle is being operated in city conditions, the integrated MH-VC hybrid air conditioning system is operated in city duty cycle, i.e., it starts with continuous ON compressor for some time, say, for example, first half an hour, which corresponds to the first predetermined time period and then the system switches over to intermittent ON mode for a balance drive cycle wherein the second and the third timers are activated and the switching happens after the second and the third predetermined time periods alternately. The second and the third predetermined time periods are determined based on the half cycle time of the metal hydride (MH) air conditioning system and other operational parameters. For instance, the second predetermined time period and the third predetermined time period are 180 seconds and 60 seconds respectively, when the half cycle time of the MH air conditioning system is 240 seconds. In another instance, when the half cycle time of the MH air conditioning system is 300 seconds, the second predetermined time period and the third predetermined time period are 180 seconds and 120 seconds respectively.

In an embodiment of the present disclosure, the MH-VS hybrid air conditioning system 10 includes a third sensor mounted on the engine 30 of the automobile to sense speed of the engine 30 and generate a third sensed signal. A third comparator, in the control unit, compares value of the third sensed signal with a first predetermined speed value and a second predetermined speed value that are stored in the memory. A magnetic clutch (not shown in figures) is provided, which engages the compressor of the vapour compression based air conditioning subsystem with the engine 30 when the value of the third sensed signal is less than the predetermined speed value. The magnetic clutch further disengages the compressor of the vapour compression based air conditioning subsystem from the engine 30 when the value of the third sensed signal is greater than the second predetermined speed value. For instance, in highway conditions, the integrated MH-VC hybrid air conditioning system starts with a continuously ON compressor for, say, 30 minutes and then the compressor is intermittently ON for internal city roads, and is continuously OFF during cruising speeds, as detected by using third sensor, which is majority of the drive time.

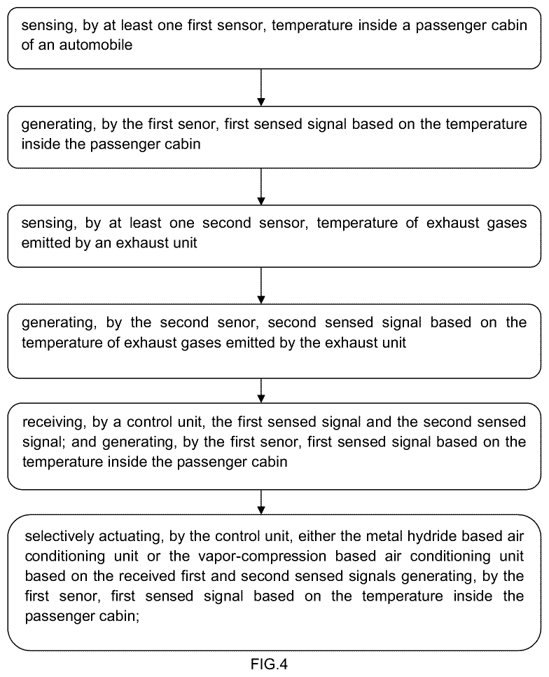

The present disclosure also envisages a method for controlling actuation of the MH-VC hybrid air conditioning system, which is shown in the flowchart of FIG. 4. The method comprises the following steps:
sensing, by at least one first sensor, temperature inside a passenger cabin of an automobile;
generating, by the first sensor, first sensed signal based on the temperature inside the passenger cabin;
sensing, by at least one second sensor, temperature of exhaust gases emitted by the exhaust unit of the engine;
generating, by the second sensor, second sensed signal based on the temperature of exhaust gases emitted by the exhaust unit of the engine;
receiving, by a control unit, the first sensed signal and the second sensed signal; and
selectively actuating, by the control unit, either the metal hydride based air conditioning subsystem or the vapour compression based air conditioning subsystem based on the received first and second sensed signals.

Preferably, the step of selectively actuating comprises following sub-steps:
storing, in a memory, a predetermined temperature value of exhaust gases, a predetermined temperature value of the passenger cabin, a first predetermined time period and a second predetermined time period;
receiving, by a converter, the first sensed signal and the second sensed signal;
converting, by the converter, the first sensed signal to a first sensed signal value and the second sensed signal to a second sensed signal value;
comparing, by a first comparator, the received first sensed signal value with the predetermined temperature value of the passenger cabin;
comparing, by a second comparator, the second sensed signal value with predetermined temperature value of exhaust gases;
generating, by a switching unit, a first activation signal, a second activation signal and a third activation signal;
actuating, by the first activation signal, the metal hydride based air conditioning subsystem when the first sensed signal value is less than the predetermined temperature value of the passenger cabin and the second sensed signal value is greater than or equal to the predetermined temperature value of the exhaust gases;
actuating, by the second activation signal, the vapour compression based air conditioning subsystem when the first sensed signal value is greater than or equal to the predetermined temperature value of the passenger cabin and the second sensed signal value is less than the predetermined temperature value of the exhaust gases; and
actuating, by the third activation signal, the vapour compression based air conditioning subsystem when the first sensed signal value is greater than or equal to the predetermined temperature value of the passenger cabin and the second sensed signal value is greater than or equal to the predetermined temperature value of the exhaust gases.

In an embodiment, the method includes following steps:
sensing, by at least one third sensor, speed of an engine of the automobile;
generating, by the third sensor, a third sensed signal;
receiving, by a third comparator, the third sensed signal;
comparing, by the third comparator, the received third sensed signal value with a first predetermined speed value and a second predetermined speed value;
engaging, by a magnetic clutch, a compressor unit of the vapour compression based air conditioning subsystem with said engine when value of the third sensed signal is less than the first predetermined speed value; and
disengaging, by said magnetic clutch, the compressor unit of the vapour compression based air conditioning subsystem with the engine when value of the third sensed signal is greater than the second predetermined speed value.

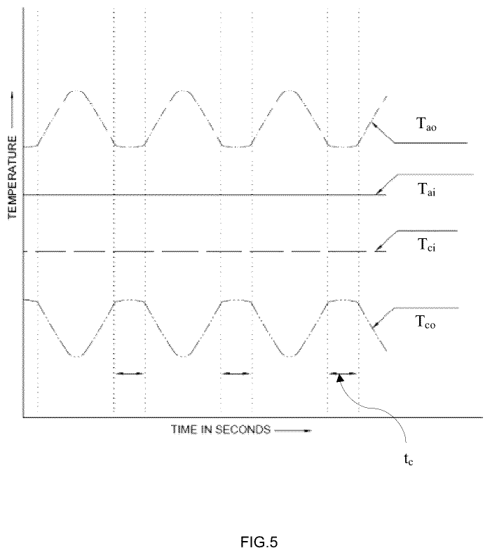

As shown in the plots of FIG. 5, the MH-VC hybrid air conditioning system 10 of the present disclosure provides temperature plot Tci of the cold air blown by the blower 40 into the passenger cabin, Tao of the hot air blown by the ambient chamber 60, wherein the plots Tci and Tao have peaks and valleys that are flattened out due to operation of the vapour compression based air conditioning subsystem for a time period tc during the changeover of hydrogen adsorption half-cycles between the LT and HT sides of the metal hydride based air conditioning subsystem. The integrated operation of the vapour compression based air conditioning subsystem with the metal hydride based air conditioning subsystem as executed by the method envisaged in the present disclosure ensures optimal fuel consumption for air conditioning.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### TECHNICAL ADVANCEMENTS AND ECONOMIC SIGNIFICANCE

The present disclosure described herein above has several technical advantages including, but not limited to, the realization of an air conditioning system for cooling a passenger cabin of an automobile, that:
ensures optimal utilization of the MH system and the VC system such that the fuel consumption conceded with the use of the VC system is minimized;
meets the cooling requirements under all possible operating conditions and use cases, reducing fluctuations in the cooling air and at the same time, minimizing frequent switching of the compressor between ON and OFF modes; and
optimizes usage of the compressor leading to substantial fuel savings without compromising comfort in the passenger cabin.

The embodiments herein and the various features and advantageous details thereof are explained with reference to the non-limiting embodiments in the following description. Descriptions of well-known components and processing techniques are omitted so as to not unnecessarily obscure the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation

1. A hybrid air conditioning system (10) for cooling a passenger cabin of an automobile, said automobile having an engine (30), said system (10) comprising:
a metal hydride based air conditioning subsystem;
a vapor compression based air conditioning subsystem;
at least one first sensor mounted in said passenger cabin of said automobile and configured to sense the temperature inside said passenger cabin to generate a first sensed signal;
at least one second sensor configured to sense the temperature of exhaust gases emitted from said engine (30) to generate a second sensed signal; and
a control unit configured to cooperate with said first sensor and said second sensor, and to selectively actuate either said metal hydride based air conditioning subsystem or said vapor compression based air conditioning subsystem based on said first and second sensed signals.

2. The system (10) as claimed in claim 1, wherein said engine (30) has an exhaust unit (310) for emitting exhaust gases therefrom, said second sensor being mounted in said exhaust unit (310) for sensing the temperature of the exhaust gases emitted from said exhaust unit (310).

3. The system (10) as claimed in claim 1, wherein said control unit includes:
a memory configured to store a predetermined temperature value of the passenger cabin, a predetermined temperature value of the exhaust gases, a first predetermined time period, and a second predetermined time period;
a converter configured to convert said first and second sensed signals to a first sensed signal value and a second sensed signal value respectively;
a controller configured to cooperate with said converter and said memory, said controller further includes:
a first comparator configured to compare said first sensed signal value with said predetermined temperature value of the passenger cabin; and
a second comparator configured to compare said second sensed signal value with predetermined temperature value of the exhaust gases; and
a switching unit configured cooperate with said controller and said memory, and to selectively generate:
a first activation signal for activating said metal hydride based air conditioning subsystem, when said first sensed signal value is less than said predetermined temperature value of the passenger cabin and said second sensed signal value is greater than or equal to said predetermined temperature value of the exhaust gases;
a second activation signal for activating said vapor compression based air conditioning subsystem, when said first sensed signal value is greater than or equal to said predetermined temperature value of the passenger cabin and said second sensed signal value is less than the predetermined temperature value of the exhaust gases; and
a third activation signal, when said first sensed signal value is greater than or equal to said predetermined temperature value of the passenger cabin and said second sensed signal value is greater than said predetermined temperature value of the exhaust gases.

4. The system (10) as claimed in claim 3, wherein said controller further includes:
a first timer configured to generate a compression cycle activation signal for activating said vapor compression based air conditioning subsystem, upon receiving said third activation signal, for said first predetermined time period;
a second timer configured to cooperate with said first timer, and to generate a compression cycle deactivation signal for deactivating said vapor compression based air conditioning subsystem, upon completion of said first predetermined time period, for said second predetermined time period; and
a third timer configured to cooperate with said second timer, and to generate a compression cycle activation signal for activating said vapor compression based air conditioning subsystem, upon completion of said second predetermined time period, for a third predetermined time period stored in said memory.

5. The system (10) as claimed in claim 4, wherein said second timer is configured to generate a compression cycle deactivation signal for deactivating said vapor compression based air conditioning subsystem, upon completion of said third predetermined time period, for said second predetermined time period.

6. The system (10) as claimed in claim 1, wherein said system (10) includes:
at least one third sensor mounted on said engine (30) of said automobile and configured to sense the speed of the engine (30) to generate a third sensed signal;
a third comparator, in said control unit, configured to compare a value of said third sensed signal with a first predetermined speed value and a second predetermined speed value stored in said memory; and
a magnetic clutch configured to engage a compressor (230) of said vapor compression based air conditioning subsystem with said engine (30) when the value of said third sensed signal is less than said first predetermined speed value, and to disengage the compressor (230) of the vapor compression based air conditioning subsystem from said engine (30) when the value of said third sensed signal is greater than said second predetermined speed value.

7. The system (10) as claimed in claim 1, wherein said metal hydride based air conditioning subsystem comprises:
a first heat exchanger configured to continuously absorb heat from said passenger cabin of said automobile and release cooled air to said passenger cabin of said automobile, said first heat exchanger housing a cold side reactor bank (110);
a second heat exchanger configured to continuously release heat to ambient air outside said automobile, said second heat exchanger housing a first ambient side reactor bank (120a);
a third heat exchanger configured to continuously release heat generated by said exhaust gases to ambient air outside said automobile, said third heat exchanger housing a second ambient side reactor bank (120b); and
a fourth heat exchanger configured to continuously absorb heat generated by said exhaust gases emitted by said exhaust unit (310), said third heat exchanger housing a hot side reactor bank (130).

8. The system (10) as claimed in claim 7, wherein said first and second heat exchangers are disposed within a low temperature module, and said third and fourth heat exchangers are disposed within a high temperature module.

9. The system (10) as claimed in claim 7, wherein said second and third heat exchangers are coupled with at least one heat rejection fan (140a, 140b) to release the heat to ambient air, outside said automobile.

10. The system (10) as claimed in claim 7, wherein said first heat exchanger is coupled to at least one blower (40) to induce cooled air into said passenger cabin of said automobile.

11. The system (10) as claimed in claim 1, said vapor compression based air conditioning system comprising:
an evaporator (210) configured to continuously absorb heat from said passenger cabin of said automobile by a low pressure and low temperature liquid refrigerant to obtain a low temperature and low pressure vapor;
a compressor, being driven by said engine (30) of said automobile, configured to compress the low temperature and low pressure vapor refrigerant leaving said evaporator (210) to obtain a high pressure and high temperature vapor refrigerant;
a condenser (230) configured to condense the high pressure and high temperature vapor refrigerant leaving said compressor to obtain a high pressure and high temperature liquid refrigerant; and
an expansion valve (240) configured to reduce pressure and temperature of the high pressure and high temperature liquid refrigerant leaving said condenser (230) to obtain the low pressure and low temperature liquid refrigerant that is passed continuously to said evaporator (210).

12. A method for controlling actuation of either a metal hydride based air conditioning subsystem or a vapor compression based air conditioning subsystem, said method comprising following steps:
sensing, by at least one first sensor, temperature inside a passenger cabin of an automobile;
generating, by said first sensor, first sensed signal based on the temperature inside said passenger cabin;
sensing, by at least one second sensor, temperature of exhaust gases emitted by an exhaust unit;
generating, by said second sensor, second sensed signal based on the temperature of exhaust gases emitted by said exhaust unit (310);
receiving, by a control unit, said first sensed signal and said second sensed signal; and
selectively actuating, by said control unit, either said metal hydride based air conditioning subsystem or said vapor compression based air conditioning subsystem based on said received first and second sensed signals.

13. The method as claimed in claim 12, wherein the step of selectively actuating comprises following sub-steps:
storing, in a memory, a predetermined temperature value of exhaust gases, a predetermined temperature value of said passenger cabin, a first predetermined time period and a second predetermined time period;
receiving, by a converter, said first sensed signal and said second sensed signal;
converting, by said converter, said first sensed signal to a first sensed signal value and said second sensed signal to a second sensed signal value;
comparing, by a first comparator, said received first sensed signal value with said predetermined temperature value of said passenger cabin;
comparing, by a second comparator, said second sensed signal value with predetermined temperature value of exhaust gases;
generating, by a switching unit, a first activation signal, a second activation signal and a third activation signal;
actuating, by said first activation signal, said metal hydride based air conditioning subsystem when said first sensed signal value is less than or equal to said predetermined temperature value of the passenger cabin and said second sensed signal value is greater than or equal to said predetermined temperature value of the exhaust gases;
actuating, by said second activation signal, said vapor compression based air conditioning subsystem when said first sensed signal value is greater than or equal to said predetermined temperature value of the passenger cabin and said second sensed signal value is greater than or equal to the predetermined temperature value of the exhaust gases; and
actuating, by said third activation signal, said vapor compression based air conditioning subsystem when said first sensed signal value is greater than or equal to said predetermined temperature value of the passenger cabin and said second sensed signal value is less than or equal to said predetermined temperature value of the exhaust gases.

14. The method as claimed in claim 12, wherein said method includes following steps:
sensing, by at least one third sensor, speed of an engine of said automobile;
generating, by said at least one third sensor, a third sensed signal;
receiving, by a third comparator, said third sensed signal;
comparing, by said third comparator, said received third sensed signal value with a first predetermined speed value and a second predetermined speed value;
engaging, by a magnetic clutch, a compressor unit of said vapor compression based air conditioning subsystem with said engine when value of said third sensed signal is less than said first predetermined speed value; and
disengaging, by said magnetic clutch, said compressor unit of said vapor compression based air conditioning subsystem with said engine when value of said third sensed signal is greater than said second predetermined speed value.
